(19) United States
(12) Patent Application Publication
(10) Pub. No.: US 2009/0157745 A1
(43) Pub. Date: Jun. 18, 2009

(54) ADDRESS CORRECTION OPTIMIZATION SYSTEM AND METHOD

(75) Inventor: Douglas B. Quine, Bethel, CT (US)

Correspondence Address: PITNEY BOWES INC.;35 WATERVIEW DRIVE, P.O. BOX 3000, MSC 26-22, SHELTON, CT, 06484-8000, US

(73) Assignee: Pitney Bowes Inc., Stamford, CT (US)

(21) Appl. No.: 11/955,420

(22) Filed: Dec. 13, 2007

(51) Int. Cl. G06F 17/00

(52) U.S. Cl. 707/104.1; 707/E17.009

(57) ABSTRACT

According to some embodiments, a method and a system are provided to store data regarding a plurality of patterns among recipients listed in a mailing list, and determine whether to request an address correction service for a mailing to the recipients based on (a) a planned date for the mailing and (b) the stored data.

### BACKGROUND

Mass mailers, such as universities, charities and corporations frequently send individual mailings in an order of 500 or more mail pieces. The mailers are consistently faced with complex decisions on how to send mass communications or solicitations to their respective customers, clients, or employees. In addition to costs associated with creating a mass mailing and maintaining a mailing list associated with the mailing, mass mailers seek to minimize postage costs by presorting the mailing (i.e. sorting the mailing by Zone Improvement Plan (“ZIP”) codes prior to the mailing being sent to the United States Postal Service (“USPS”)) to be eligible to obtain a postal discount.

Mass mailers must balance between tradeoffs associated with different presorted mailing classes such as first class and standard class. For example, first class mail provides fast delivery and free forwarding if a mail recipient has moved while standard class mail does not provide automatic forwarding of the mail piece but does provide a lower postage cost than first class. This balancing act is further complicated by several factors including mail recipients that move frequently and mandates by the USPS that the mailers shall obtain address updates within a specific timeframe in order to qualify for the cost savings of presorted mail.

### SUMMARY

Generally, a method and a system are provided to store data regarding a plurality of patterns associated with recipients listed in a mailing list, and determine whether to request an address correction service for a mailing to the recipients based on (a) a planned date for the mailing and (b) the stored data.

Therefore, it should now be apparent that the invention substantially achieves all the above aspects and advantages. Additional aspects and advantages of the invention will be set forth in the description that follows, and in part will be obvious from the description, or may be learned by practice of the invention. Various features and embodiments are further described in the following figures, descriptions, and claims.

### BRIEF DESCRIPTION OF THE DRAWINGS

The accompanying drawings illustrate presently preferred embodiments of the invention, and together with the general description given above and the detailed description given below, serve to explain the principles of the invention. As shown throughout the drawings, like reference numerals designate like or corresponding parts.

FIG. 1 illustrates a method according to some embodiments.

FIG. 2 illustrates a method according to some embodiments.

FIG. 3 illustrates a method according to some embodiments.

FIG. 4 illustrates a system according to some embodiments.

FIG. 5 illustrates a portion of an envelope according to some embodiments.

### DETAILED DESCRIPTION

The several embodiments described herein are provided solely for the purpose of illustration. Embodiments may include any currently or hereafter-known versions of the elements described herein. Therefore, persons in the art will recognize from this description that other embodiments may be practiced with various modifications and alterations.

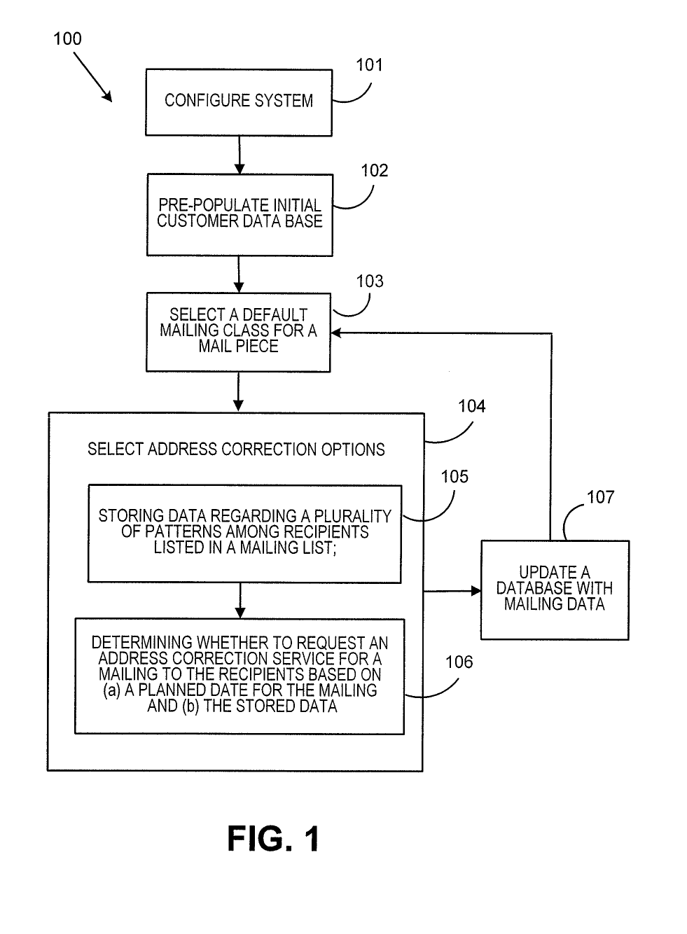

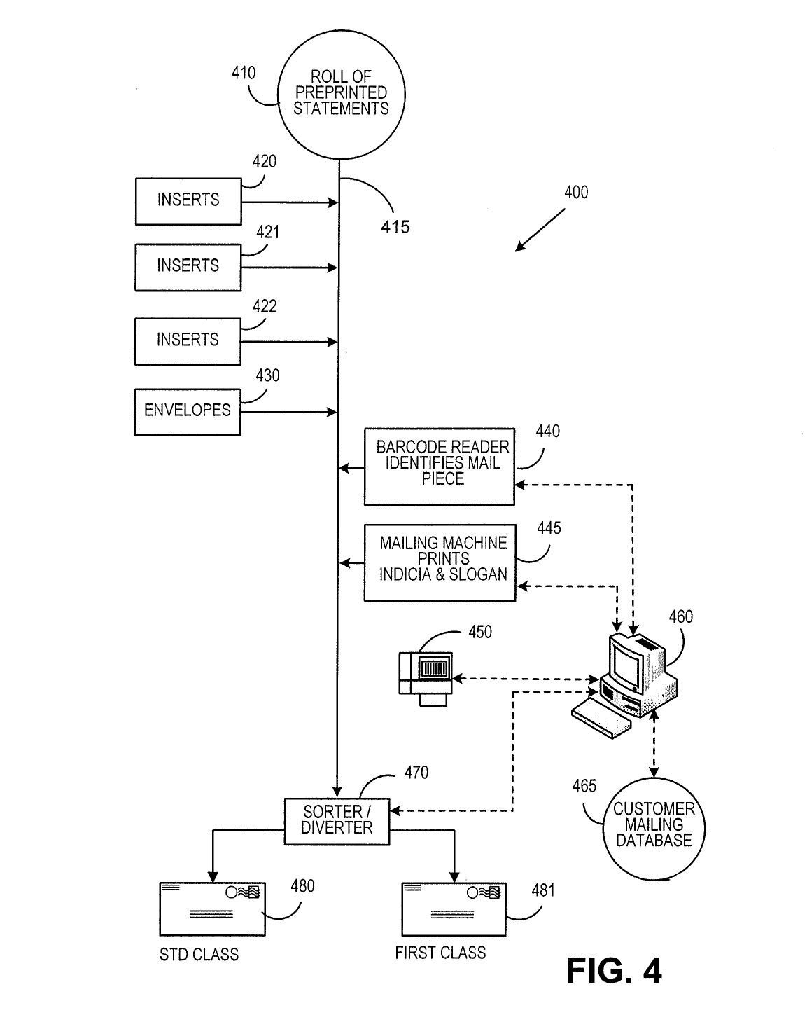

Now referring to FIG. 1, an embodiment of a method 100 is illustrated. At 101, a system may be configured. The system may be, but is not limited to, the system 400, of FIG. 4. In some embodiments, the system may comprise a computing system that directs a mailer to select a mail class and an address correction option on a mailing machine (e.g. postage meter or addressing machine). In some embodiments, the system may be configured by selecting a type of organization such as, but not limited to, a university, a charity, or a company. In some embodiments, the system may be configured with a plurality of parameters or rules associated with a mailing pattern of an organization. The system may comprise a database, such as customer mailing database 465 of FIG. 4, and before the system may function, the database may be pre-populated with an initial customer list and associated customer data at 102.

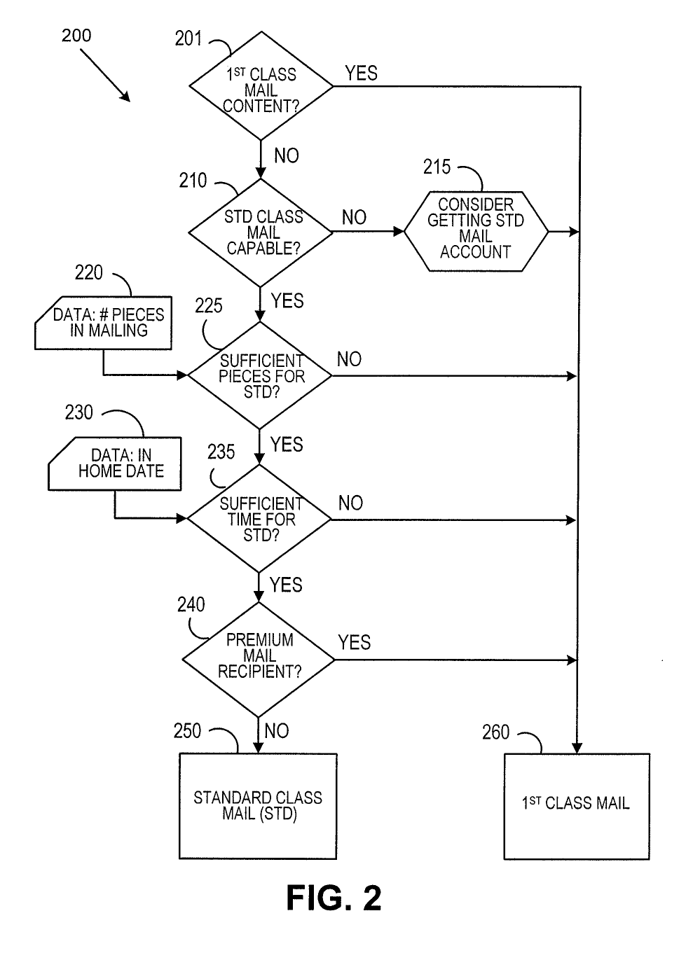

Once the system has been configured and the database has been pre-populated with initial customer data, the system may receive a plurality of mail pieces. At 103, the mailing class may be determined for a first of the plurality of mail pieces. In some embodiments, the mailing class may be determined by a method, such as method 200 of FIG. 2.

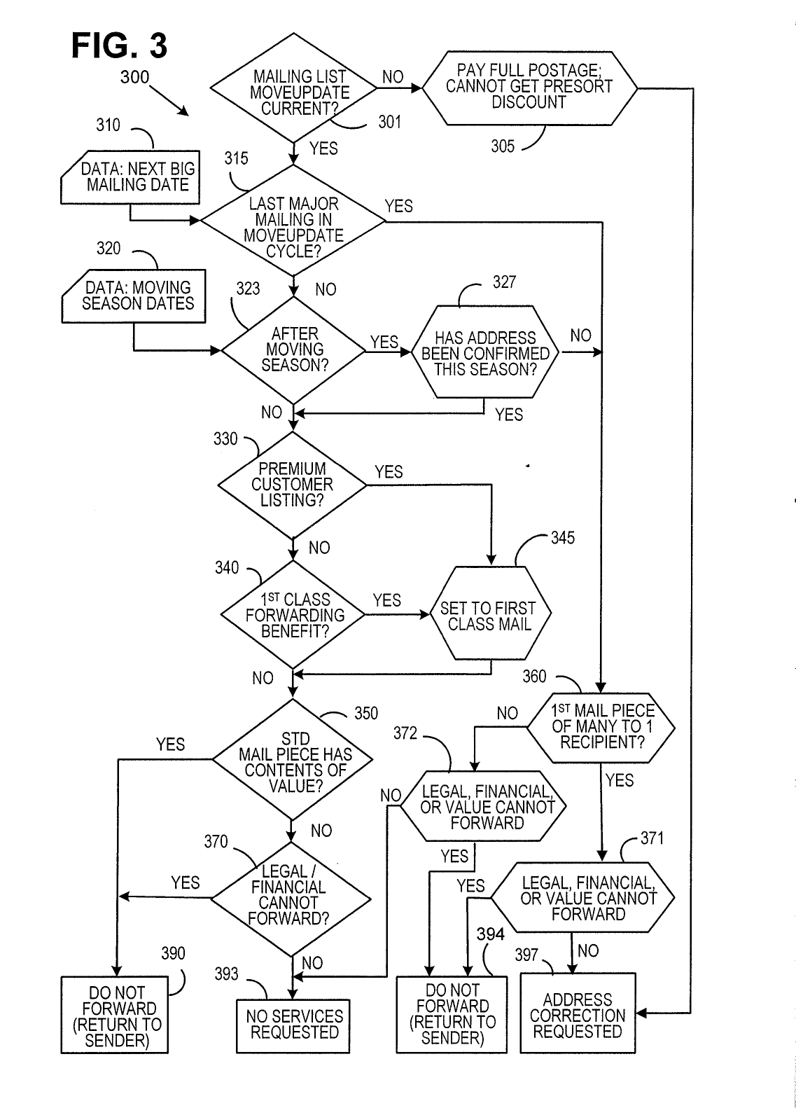

Once the mail piece has been associated with a mailing class, an address correction option is selected for the mail piece at 104. In some embodiments, an address correction option may be determined by a method, such as method 300 of FIG. 3.

In some embodiments, the selecting of an address correction option, may comprise storing data regarding a plurality of patterns associated with recipients listed in a mailing list at 105 and determining whether to request an address correction service for a mailing to the recipients based on a planned date for a mailing and the stored data at 106 to ensure compliance with the USPS Move Update requirement.

The data may comprise, but is not limited to, customer data, one or more mail types, and one or more recipient types. In some embodiments, the recipient types may comprise an indication that a mail recipient is a premium recipient, or a non-premium recipient. A premium recipient may be an important recipient such as, but not limited to, a financial donor, an important customer, a public figure, or a political figure. For example, if a charity is sending out an annual solicitation for donations then donors who are known to donate large sums of money may be singled out as premium recipients because the charity may wish to use a special invitation, a special stamp, or first class mail to further personalize communications for the premium recipients.

In some embodiments, recipient types may comprise indications of a class of recipient. For example, recipients may be classified as employees, customers, students, or graduates to focus the mailing to a particular group. In some embodiments a recipient type of ALL may include employees, customers, students, and graduates.

The customer data may comprise information associated with the mail recipients. For example, if the mail recipients move often (i.e. change their address frequently) then mail sent to those recipients may be returned to the sender at a higher rate than recipients who do not move. The frequency of return is measured as a return mail rate which may be included in the customer data for one or more of the mail recipients. In some embodiments, the customer data may also comprise an address update compliance date (i.e. to ensure addresses have been updated within a specific timeframe as required by a postal service), a standard class mail capability (i.e. a determination if the sender is eligible to send standard class mail such as, but not limited to, advertisements, flyers, and solicitations), one or more moving season dates (i.e. dates that mail recipients typically move), a next planned major mailing date, a number of pieces in a mailing, and an in home date (i.e. a date that a mail piece is required to be delivered).

In some embodiments, the plurality of patterns may be derived from historical data associated with different types of senders (i.e. a sender's business model), and types of recipients. For example, for a university business model the plurality of patterns may be based on seasonal address changes such as, but not limited to, university students who move to a dormitory address in the fall, move back home during winter break, move back to school after the winter break, and finally move back home when school is out of session.

USPS Move Update compliance is required for mailers who claim presort or automation rates. Since mailers must demonstrate that they have updated the addresses in their mailing lists within a specific timeframe prior to the mailing date, the USPS provides service such as ACS™, Ancillary Service Endorsements, FASTforward®, and NCOALink® to assist mailers in meeting their needs. In some embodiments, a system may analyze the stored data to make the determination whether to request an address correction service and the planned date for the mailing may indicate to the system if a mailing will be sent within the specific timeframe specified by the postal service.

Next at 107, the database is updated with mailing data associated with the mail piece. The data may include the selection of a mailing class and the selection of an address correction option. The method may repeat for each mail piece in the plurality of mail pieces.

Now referring to FIG. 2, an embodiment of a method 200 is illustrated. Method 200 may be performed by a system such as, but not limited to, system 400 of FIG. 4. At 201, a determination is made if a mail piece includes first class content such as personal correspondence, bills, financial statements, and/or legal documents. In some embodiments, the determination may be partially based on an input of a content type provided to a mailing system. If the mail piece comprises first class content then the mail piece is indicated as first class mail at 260.

If the mail piece does not comprise first class content, then at 210 a determination is made if the sender is capable of sending standard class mail. In some embodiments the determination may be based on a number of mail pieces sent in a single mailing and/or if the sender has met all requirements of a postal service for standard class mail. For example, if the sender only sends one hundred pieces in a mailing, the mailing will not quality for standard class mail. If the sender does have the capability to send standard class mail then the process continues at 225. In some embodiments, if the mailer makes large mailings without first class content, the system may suggest at 215 that the sender should consider setting up a standard mail account.

At 225, an input of an amount of mail pieces 220 being sent in a mass mailing may be received. If the amount of mail pieces is greater than or equal to the number of mail pieces required for standard class mail then the mail pieces may be sent via standard class mail. If the amount of mail pieces is less than the required number of mail pieces then the mail pieces are indicated as being sent via first class at 260. Proceeding to 235, a determination is made if there is sufficient time for the mail pieces to be sent via standard class mail. In general, standard class mail takes longer to be delivered than first class mail and the determination of sufficient time may be based on a date that each mail piece is required to be delivered such as an in home date 230. If it is determined that there isn't sufficient time for the mail piece to be delivered then the mail piece may be sent via first class mail at 260, otherwise the process proceeds to 240. If at 240, the recipient is determined to be a premium recipient then the mail piece is sent via first class at 260 otherwise the mail piece is sent via standard class mail at 250.

In the case of a university mailer, a postage rate for a flyer and a postage rate for a tuition bill may be determined by the method of FIG. 2. When determining a rate for the flyer, at 201 the flyer (i.e. a solicitation) is not first class content and thus could be sent as standard class mail. At 210, the university, being a large organization, may be capable of sending standard class mail (i.e. the university meets the requirements set out by the USPS) and with a large student body may meet the number of pieces required for standard class mail. Since the flyer does not need to be delivered by a specific date and the student body does not comprise premium recipients, the flyer may be sent as standard class mail. When sending the tuition bill, the content may be considered first class content and the tuition bill may be sent as first class mail.

A charity mailing may also utilize the method of FIG. 2 to determine the postage rate for a plurality of solicitations. The solicitations are standard class mail content and the charity is capable of sending standard class mail. A first portion of the solicitations may be sent to potential contributors and a second portion of solicitations may be sent to known contributors. Delivery of the solicitations to the known contributors may be more important to the charity than delivery of the solicitations to potential contributors and thus the known contributors may be indicated as premium recipients. Therefore, when determining a mail rate for each solicitation if the recipient is indicated as a premium recipient then the solicitation will be sent via first class mail and if the recipient is indicated as non-premium then the solicitation will be sent via standard class mail.

Now referring to FIG. 3, an embodiment of a method 300 is illustrated. The method 300 may be implemented by any system, such as, but not limited to, the system 400 of FIG. 4. In some embodiments, FIG. 3 illustrates a decision flow for sending a mailing to a plurality of recipients.

At 301, a determination is made if a list of addresses has been updated within a USPS mandated timeframe (i.e. a move update cycle) to allow use of a presort discount rate. If the address list is not current (i.e. has not been updated), then, at 305, the mailer may have to pay a full postage amount and a request for an address correction will be printed on each mail piece at 397.

At 315, a determination is made if the current mailing will be a last major mailing to be sent within a current move update cycle. A major mailing, in some embodiments, may be a mailing that comprises over 500 recipients or may comprise a majority of recipients contained in a mailing list. The determination may be partially based on an input of a date of a next major mailing, as illustrated at 310. If the current mailing is the last major mailing to be sent, then a determination is made at 360 if multiple mail pieces in the current mailing are being sent to a same recipient and furthermore if a current mail piece is a first mail piece of the plurality of mail pieces being sent to the same recipient. If, at 371, it is determined that this mail piece is a first mail piece of the multiple mail pieces being sent to the same recipient and the content of the mailing is of a legal nature, a financial nature, or contains valuable content (i.e. the mail piece cannot be forwarded), then the mail piece will be endorsed “do not forward” at 394. However, if it is determined at 371 that the contents of the mailing is not of a legal nature, a financial nature and does not contain valuable content then an address correction may be requested at 397.

If a determination is made at 360 that multiple mail pieces in the current mailing are not being sent to a same recipient then the method proceeds to 372. If, at 372, it is determined that the content of the mailing is of a legal nature, a financial nature, or contains valuable content, then the mail piece will be endorsed “do not forward” at 394. However, if it is determined at 372 that the contents of the mailing is not of a legal nature, a financial nature and does not contain valuable content then no services are requested at 393.

Returning to 315, if it is determined that other major mailings will be sent after the current mailing and during the current move update cycle, then at 323 it may be determined if the current mailing is being sent after a moving season based at least on an input 320 of moving season dates. If the current mailing being sent is after the moving season, then a determination is made at 327 if each mail recipient's address has been confirmed. If the addresses have not been confirmed then a determination is made at 360, 371, and 372 to request no services, request address correction, or to mark as do not forward as previously described.

Next, looking back at 323, if a determination is made that the current mailing will be sent before moving season or if an address confirmation had been made at 327, then the method proceeds to 330. At 330, if the mail recipient is determined to be a premium recipient then the mail piece may be set to first class mail at 345.

If the mail recipient is determined to be a non-premium recipient, then at 340 a determination is made if the mail piece would benefit by being sent first class. For example, if a sender has a high rate of undeliverable mail pieces to this category of recipients, the sender may desire to have all mail pieces forwarded which may make sending the mail piece via first class mail most cost effective. A university that has a large turnover rate of students may have a very high undeliverable rate while an employer where employees stay for many years will have a low rate of undeliverable mail pieces.

If the mail piece would benefit from being sent first class then at 345 the mail piece is set to first class mail else it remains as it was and the method proceeds to 350. In some embodiments, an initial default mail class may be determined by a method such as, but not limited to, method 200 of FIG. 2.

If, at 350, it is determined that the content of the mail piece contains valuable content, then the mail piece is marked as “do not forward” at 390. If the contents of the mail piece are not valuable but a determination is made at 370 that the content of the mail piece of the mailing is of a legal nature or a financial nature (i.e. the mail piece cannot be forwarded), then the mail piece is marked as “do not forward” at 390. However, if it is determined at 370 that the contents of the mailing are not of a legal nature or a financial nature then no services are requested at 393.

For illustrative purposes, and to aid in understanding features of the aforementioned method, examples from four mailers will now be introduced. These examples are not intended to limit the scope of the invention.

The first mailer is a university that sends numerous mailings to the student body. For example, the university may send tuition bills and school sport promotions. The second mailer is an employer that may send tax documents and/or flyers associated with a company event (i.e. a holiday party or annual picnic) to employees. The third mailer is a charity that sends out a solicitation to previous donors and potential donors and the fourth mailer is a stock brokerage that sends out trade confirmations. For each example it will be assumed that a postal regulation states that in order to qualify for a presort discount, addresses must be updated every 6 months and that an address correction costs fifty cents per mail piece that is marked for address correction.

Looking at the first mailer, if the university at 301 has decided to send out a promotional flyer for a basketball tournament using a currently approved mailing list and the promotional flyer will not be the last major mailing before a required move update at 315 (i.e. there will be other mass mailings) then the decision flow proceeds to 323. If, at 323, the flyer will be sent before the students move home for winter break (e.g. a moving season), then it may be determined that a flyer (i.e. an advertisement) will not distinguish premium customers at 330, will not require forwarding at 340, has no commercial value at 350 or legal content at 370. Therefore, the decision flow ends at 393 and no services are required for sending the standard class flyer for the basketball tournament.

However, if the promotional flyer will be the last major mailing before a required move update at 315 then it may be cost efficient for the university to request an address correction. Therefore, the decision flow proceeds to 360. With only one mail piece sent per household, the decision flow passes to 371. Since the flyer is not of a legal nature, the process flow ends at 397 and an address correction is requested for each unique mail recipient.

The university may send a tuition bill to the student body late in the fall term for the next semester's bill and thus the tuition bill is sent after the moving season. At, 327 the university may confirm that each student's address has been confirmed. If an address of an individual student has not been confirmed, then the decision flow proceeds to 360 for each mail piece with an unconfirmed address as described above and the tuition may be sent requesting an address correction. However, if the address has been confirmed then the process flow may continue at 330 as described above. Since the bill is first class content (as determined with respect to FIG. 2), it will be mailed first class and no special services will be requested 393.

The second mailer is an employer that sends a tax document at the end of the year to each employee. If the tax document is the last major mailing in a move update cycle then at 360 the process continues to 371 since its each employee only receives one document. At 371, it will be determined that the tax document is confidential financial information and therefore the mail piece will be marked “Do Not Forward” (return to sender) at 394.

When the employer sends a flyer about a company picnic then it may be determined that the flyer will not distinguish premium customers at 330, will not require forwarding at 340, has no commercial value at 350 or legal content at 370. Therefore, the decision flow ends at 393 and no services are required for sending the flyer regarding the company picnic.

The next mailer, the charity, focuses on the premium customer determination at 330. Since a premium recipient may be an important recipient such as someone who frequently donates large sums of money to the charity, the charity may desire to treat this individual in a special manner such as using a special invitation, a special stamp, or a special delivery method for each premium recipient. For example, if a recipient is determined to be premium, then the sender may be willing to send the envelope first class for automatic forwarding and may desire to request address correction on each solicitation to ensure that the premium recipient's address is always updated and that the premium recipient always receives the solicitation.

The stock brokerage mailer focuses on requesting an address correction for a first mail piece of many mail pieces addressed to a same recipient at 360. The stock brokerage that services a stock trader (e.g. a day trader) may, at the end of a trading day, send an individual confirmation for each trade the trader made that day. For example, if the trader bought 5 stocks and sold 5 stocks, the trader may receive 10 trade confirmations. If the stock brokerage were to send all of their trade confirmations out as a part of a daily mass mailing and if this mass mailing were the last mailing in a move update cycle, the stock brokerage would have requested an address correction service by printing an address correction endorsement on each mail piece. By this method, at 360 the first trade confirmation may have an address correction endorsement while the next nine confirmations do not have an address correction endorsement. By only printing an address correction for a single mail piece, a cost savings may be realized. For example, if an address correction endorsement costs 50 cents as described above, the stock brokerage will have only paid 50 cents instead of 5 dollars for an address correction for this individual. Therefore, by comparing a current recipient with stored data comprising recent mailing history, redundant address correction payments may be prevented.

Now referring to FIG. 4, an embodiment of a system 400 is illustrated. The system 400 may comprise a roll of preprinted statements 410, a plurality of inserts 420/421/422, a plurality of envelopes 430, a barcode reader 440, an indicia printer 445, a manifest printer 450, a customer database system 465, computer system 460, a sorter 470, a standard class output stacker 480, and a first class output stacker 481.

The computer system 460 may comprise a processor, a plurality of memory devices, and a medium that stores computer readable instructions. The computer readable instructions when executed by a processor may perform a method such as, but not limited to, method 200 of FIG. 2 and/or method 300 of FIG. 3. The computer system 460 may be electronically coupled to the barcode reader 440, the mailing machine 445, the manifest printer 450, the sorter/diverter 470, and the customer mailing database 465.

The roll or preprinted statements 410 may comprise a plurality of bills, tax statements, solicitations, or any other preprinted mail content. The system 400 may insert the preprinted statements 410 into a respective one of envelopes 430 while a mail piece travels via a path 415. In some embodiments, the system may also insert one or more inserts 420/321/322 into the envelopes 430 with the prepared statements 410.

The customer database system 465 may store customer data that comprises return mail rates, recipient addresses, dates of address correction for each recipient, indications of content type, address update compliance dates, a standard class mail capability, one or more moving season dates, a next planned major mailing date, a number of pieces in a mailing, and an in home date. The customer database system 465 may also store a plurality of recipient types such as, but not limited to, indications that a mail recipient is a premium recipient or a non-premium recipient, indications of a class of recipient types. In some embodiments, the customer database system 465 may store a plurality of mailing lists. In some embodiments and during initialization of the system 400, each mailing list may comprise a pre-populated mailing list based on recipient profiles to enable default seasonal patterns to be utilized until new data is gathered.

In some embodiments, each envelope 430 and envelope address may be scanned by a barcode reader 440 to identify each mail piece to the computer system 460. The barcode reader may for example read a POSTNET barcode (not shown) on each mail piece. The POSTNET barcode may reflect an 11-digit ZIP code that uniquely identifies the destination address for the mail piece. In response to receiving the scanned mail piece information, the system 400 may store the scanned information into the customer database system 465 and the system 400 may lookup the mail recipient in the customer mailing database 465 to retrieve customer data. Once the customer data has been retrieved and the envelopes 430 include the prepared statements 410 then the computer system 460 may perform a method, such as, but not limited to method 200 of FIG. 2 and method 300 of FIG. 3.

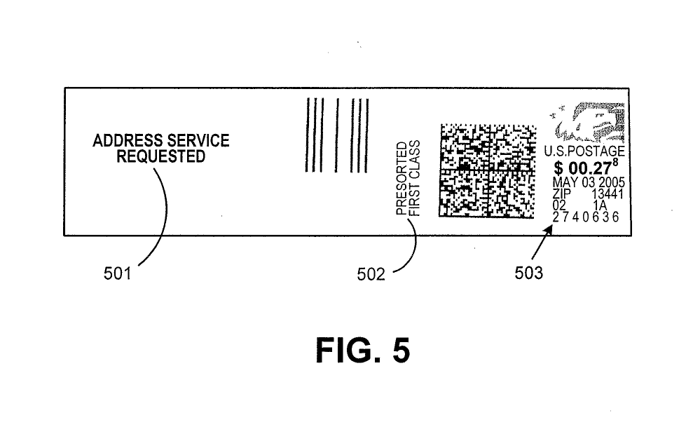

As each mail piece is scanned and a determination is made whether to send the mail pieces via first class or standard class, the mailing machine 445 may print indicia and slogans on the mail piece such as those illustrated with respect to FIG. 5. In some embodiments the mailing machine 445 may print indicia for standard class mail and in some embodiments the mailing machine 445 may print indicia for first class mail. In yet another embodiment, the mailing machine 445 may print a portion of the mail pieces with first class indicia and a portion of the mail pieces with standard class indicia. The mailing machine 445 may print endorsements, such as an address service requested endorsement 501 as illustrated in FIG. 5, on selected mail pieces based on the customer data stored in the customer database system 465.

The printer 450 may print a first manifest (i.e. a listing of each mail piece) for first class mail and a second manifest for standard class mail. In some embodiments a single manifest may comprise both first class mail and standard class mail. After each mail piece has been printed with an indicia and entered into a manifest, the sorter 470 may sort each mail piece and send each mail piece to either a standard class output stacker 480 or a first class output stacker 481. In some embodiments there may be a multiplicity of standard class stackers and a multiplicity of first class stackers to allow presort of such mail pieces to achieve postal discounts.

Now referring to FIG. 5, an embodiment of a portion of an envelope is illustrated. As illustrated, the envelope comprises an address correction service endorsement 501, a mail class indication 502, and postage indicia 503.

A number of embodiments of the present invention have been described. Nevertheless, it will be understood that various modifications may be made without departing from the spirit and scope of the invention. Other variations relating to implementation of the functions described herein can also be implemented. Accordingly, other embodiments are within the scope of the following claims.

What is claimed is:

1. A method comprising:
storing data regarding a plurality of patterns associated with recipients listed in a mailing list; and
determining whether to request an address correction service for a mailing to the recipients based on (a) a planned date for the mailing and (b) the stored data.

2. The method of claim 1, wherein the plurality of patterns is based on seasonal address changes.

3. The method of claim 1, wherein the stored data comprise at least customer data, a mail type, a first recipient type, and a second recipient type.

4. The method of claim 4, wherein the customer data comprises one or more return mail rates, an address update compliance date, a standard class mail capability, one or more moving season dates, a next planned major mailing date, a number of pieces in a mailing, and an in home date.

5. The method of claim 4 wherein the first recipient type comprises a premium, or non-premium indication.

6. The method of claim 4, wherein the second recipient type comprises employees, customers, students, graduates, or all.

7. The method of claim 1, wherein the address correction service is a Move Update received from the United States Postal Service.

8. The method of claim 1, further comprising:
selecting a mailing class to optimize a total mailing cost of a mailing.

9. The method of claim 8, wherein the selecting is based on if a mailer wishes to retrieve a contents of the mailing if the mailing is undeliverable.

10. The method of claim 1, wherein the mailing list is pre-populated based on recipient profiles to enable default seasonal patterns to be utilized until new data is gathered.

11. The method of claim 1, further comprising:
tracking the plurality of patterns.

12. The method of claim 1, wherein the stored data comprises a recent mailing history to prevent redundant address correction payments.

13. A system comprising:
a processor;
a computer readable medium to store instructions that when executed by the processor perform a method, the method comprising:
storing data regarding a plurality of patterns among recipients listed in a mailing list; and
determining whether to request an address correction service for a mailing to the recipients based on (a) a planed date for the mailing and (b) the stored data.

14. The system of claim 13, wherein the plurality of patterns is based on seasonal address changes.

15. The system of claim 13, wherein the stored data comprise at least customer data, a mail type, a first recipient type, and a second recipient type.

16. The system of claim 15, wherein the customer data comprises one or more return mail rates, an address update compliance date, a standard class mail capability, one or more moving season dates, a next planned major mailing date, a number of pieces in a mailing, and an in home date.

17. The system of claim 15 wherein the first recipient type comprises a premium, or non premium indication.

18. The system of claim 15, wherein the second recipient type comprises employees, customers, students, graduates, or all.

19. The system of claim 13, wherein the stored data comprises a recent mailing history to prevent redundant address correction payments.
